(19) United States
(12) Patent Application Publication
(10) Pub. No.: US 2003/0132861 A1
(43) Pub. Date: Jul. 17, 2003

(54) Global positioning system receiver with an infrared transmitter

(76) Inventor: Jordan Shieh, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/053,267

(22) Filed: Jan. 17, 2002

(51) Int. Cl. G08G 1/123

(52) U.S. Cl. 340/990; 340/995.1

(57) ABSTRACT

A global positioning system (GPS) receiver with a signal I/O port, a power connector and an infrared (IR) transmitter is capable signal transmission to peripheral equipment either by cable connection through the signal. I/O port or directly by wireless means using the IR transmitter.

### BACKGROUND OF THE INVENTION

1. Field of the Invention

The present invention relates to a GPS receiver equipped with an IR transmitter, such that the signal path to peripheral equipment can be completed either by wireless means using the IR transmitter or through a cable, thus providing users with more options in establishing a signal path.

2. Description of Related Art

Thanks to the recent advance in global positioning system (GPS) technology, this technology is being put to good use in our daily life. For example GPS is now used in land vehicles for navigation. GPS receives satellite signals at regular intervals (for example, every 0.1 sec) and then converts the signals to a digital format. Coordinates representing a position on an electronic-based map are computed to mark the position of a moving vehicle, such that drivers can be instantly updated on the road information. GPS for cars can also be linked to a vehicle protection and management system for tracking down stolen cars, by pinpointing the location of stolen cars, so that car owners can use the information to recover their cars.

For vehicles without a factory installed GPS or a built-in GPS receiver, there is a type of GPS adapted for external connection. With reference to FIG. 3, a conventional type of GPS for external connection has a receiving set (30) and a signal I/O port (32). The receiving set (30) is attached to a signal line (31), and the signal I/O port (32) (PS2 interface is used in this example) is fixed on the other end of said signal line (31). When said GPS receiver is connected to a portable equipment such as a notebook PC or a personal digital assistance (PDA) with some kind of GPS-based operation software running in the machine, the user will be able to obtain the necessary road information instantly shown on the peripheral screen. However, said GPS receiver and the PDA-like peripheral require some kind of adapter for making the port connection. The adapter comprises a cable connector (33), a power connector (34) and a signal connector for PDA (35). The cable connector (33) attaches to the signal I/O port (32) of said GPS receiver. The power connector (34) is an automobile cigarette lighter plug. The power connector (34) plugs into the cigarette lighter socket in the car to provide the operating voltage for said GPS receiver, and the signal connector for PDA (35) is connected to a PDA-like equipment.

When the GPS receiver is to be linked with a notebook PC, the user has to find another type of adapter. With reference to FIG. 4, the adapter comprises a cable connector (33) and a universal serial bus (USB) connector (36). The cable connector (33) is on one end of said adapter to connect to the signal I/O port (32) of the GPS receiver. The universal serial bus (USB) connector (36) is on the other end to connect to a USB port on a notebook PC. Since the power of the GPS receiver is drawn from the notebook PC through the USB connector (36), no power connector is needed.

There are many types of PDA equipment available, but their port specifications are not the same. As such, it is necessary to prepare many adapters with different port specifications, so that PDA users are able to find one that matches the signal ports (35) of their PDA. Furthermore, since each type of adapter can support only one type of display equipment, a variety of different adapters are needed to accommodate multiple types of display equipment, thereby creating a compatibility problem. Every time a user wants to change the display equipment, the adapter must be changed to conform to the new display equipment, such as changing the display device from a PDA to a notebook PC.

To overcome the shortcomings in the previous art, the present invention provides a GPS receiver incorporating an IR transmitter, allowing the signal path to the peripheral equipment to be completed through wireless means thereby obviating the need for any adapter.

### SUMMARY OF THE INVENTION

The main object of the present invention is to incorporate an IR transmitter into a GPS receiver, which allows the signal path to the peripheral equipment to be completed through wireless means. A GPS receiver with an IR transmitter comprises a GPS receiving set, a signal reception antenna and an IR transmitter. One end of a signal lead is attached to the GPS receiving set and the other end is attached to a signal connector. A power connector is connected to the signal connector. Signals from the GPS receiver are transmitted to the peripheral equipment through a signal I/O port to which the signal connector is attached or directly from the IR transmitter.

The features of and techniques used in the present invention will be more clearly understood from the description of the preferred embodiment when taken in conjunction with the drawings of the invention.

### BRIEF DESCRIPTION OF THE DRAWINGS

FIG. 1 is a perspective view of a first embodiment of a GPS receiver in accordance with the present invention;

FIG. 2 is a perspective view of a second embodiment of a GPS receiver in accordance with the present invention;

FIG. 3 is a schematic diagram of a conventional GPS receiver with an adapter in accordance with the prior art; and

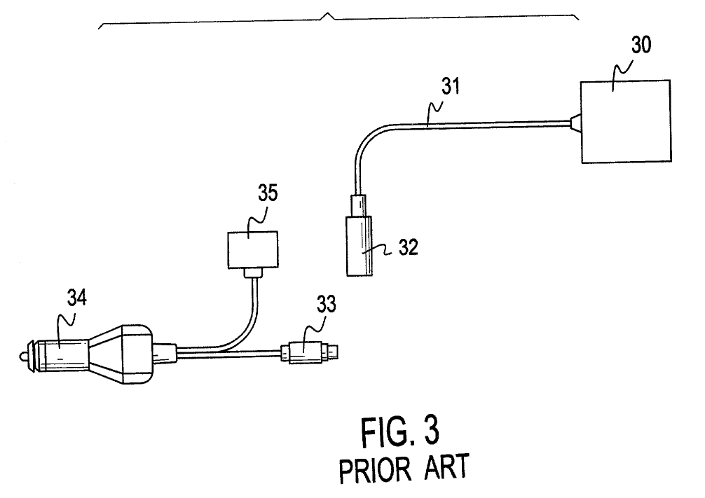

FIG. 4 is a top plan view a conventional USB adapter.

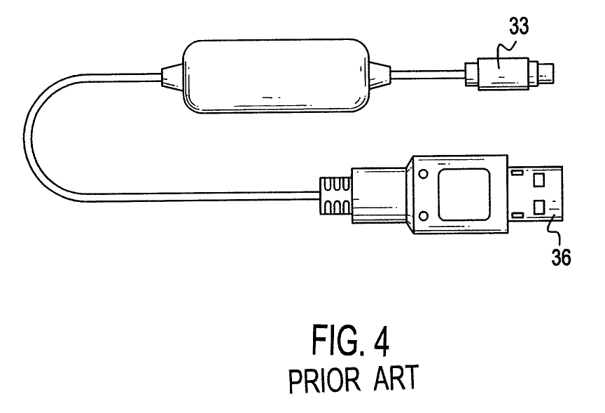

### DETAILED DESCRIPTION OF THE PREFERRED EMBODIMENT

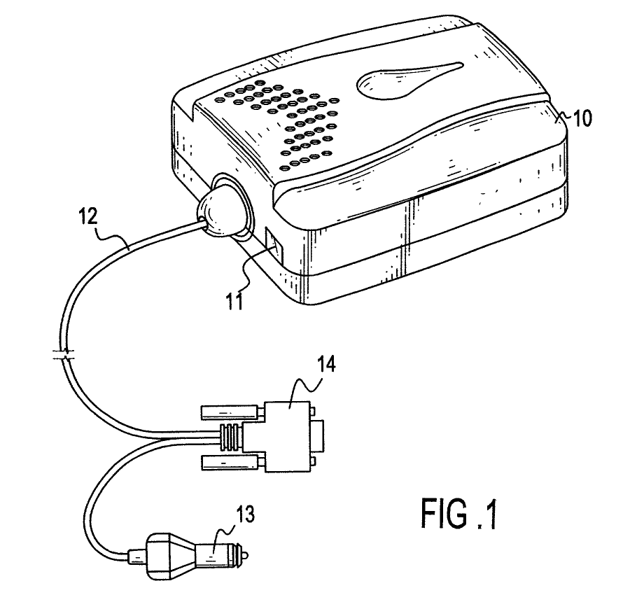

With reference to FIG. 1, the first embodiment of a global positioning system (GPS) receiver with an IR transmitter in accordance with the present invention comprises a GPS receiving set (10), an internal IR transmitter (11) and a signal lead (12). The GPS receiving set (10) has a built-in reception antenna to receive satellite signals to compute the coordinates of an object position on the electronic map. In another embodiment of the global positioning system (GPS) receiver with an IR transmitter, the IR transmitter (11) can be connected to the receiving set (10) externally. One end of the signal lead (12) is connected to the GPS receiving set (10) and the other end is connected to a cable connector (14) (an RS232 port in the present embodiment, but a PS2 or USB port could be used instead). A power connector (13) having the physical appearance of an automobile cigarette lighter is connected to the cable connector (14).

Since many types of PDAs and notebook PCs have built-in infrared transceivers, users are able to select the signal path to the peripheral equipment for the GPS receiver based on their own needs. When installing the GPS receiver in a vehicle, the power connector (13) on the receiving set (10) is connected to the cigarette lighter outlet to provide the operating voltage, and the connector port (14) is connected to a PDA or a notebook PC to establish a data. Even if the signal port specifications of said connector (14) and the PDA or notebook PC are found to be incompatible, the built-in IR transmitter (11) can be used instead, thereby avoiding the inconvenience of changing to or finding a suitable adapter.

Furthermore, under the present invention, as long as the peripheral equipment is placed within the effective range and at a suitable angle relative to the GPS receiver, the data path can be successfully established. It is also possible for the GPS receiver to engage in data communications with multiple signal reception devices simultaneously.

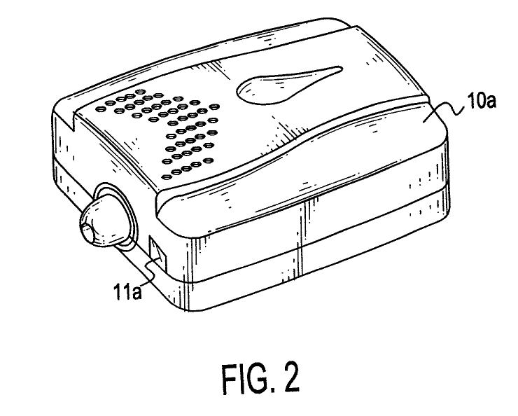

With reference to FIG. 2, a second embodiment of the global positioning system (GPS) receiver with an IR transmitter in accordance with the present invention has a GPS receiving set (10a) with a built-in IR transmitter (11a) powered by an internal battery. With this embodiment, there is no need to use an adapter to establish the data path with the peripheral equipment. Therefore, the GPS receiver in accordance with the present invention provides users with extra flexibility and eliminates the problem of tangled wires when setting up the GPS receiver.

The disclosure of the first and second embodiments of the present invention is intended to be illustrative only, and under no circumstances should the scope of the present invention be so restricted.

What is claimed is:

1. A global positioning system (GPS) receiver with IR transmitter, the GPS receiver comprising:
a receiving set including a reception antenna for receiving satellite signals to be used for computing the coordinates on an electronic map; and
an IR transmitter incorporated into the receiving set adapted to transmit signals to a display device.

2. The GPS receiver as claimed in claim 1, wherein said receiving set is attached to a signal lead with a connector and a power connector is attached to the connector.

3. The GPS receiver as claimed in claim 1, wherein said IR transmitter is built into the receiving set.

4. The GPS receiver as claimed in claim 2, wherein said IR transmitter is built into the receiving set.

5. The GPS receiver as claimed in claim 1, wherein the IR transmitter can be externally connected to the receiving set.

6. The GPS receiver as claimed in claim 2, wherein the IR transmitter can be externally connected to the receiving set.

7. The GPS receiver as claimed in claim 2, wherein the connector is designed for connectors complying with RS232 specifications.

8. The GPS receiver as claimed in claim 2, wherein the connector is designed for connectors complying with PS2 specifications.

9. The GPS receiver as claimed in claim 2, wherein the connector is designed for connectors complying with USB specifications.

10. The GPS receiver as claimed in claim 7, wherein the power connector has the physical appearance of a cigarette lighter plug for car use.

11. The GPS receiver as claimed in claim 8, wherein the power connector has the physical appearance of a cigarette lighter plug for car use.

12. The GPS receiver as claimed in claim 9, wherein the power connector has the physical appearance of a cigarette lighter plug for car use.
